(19) United States
(12) Patent Application Publication
(10) Pub. No.: US 2003/0038475 A1
(43) Pub. Date: Feb. 27, 2003

(54) Greeting card with healthcare information

(76) Inventor: Michelle D. Stancil, Calhoun Falls, SC (US)

Correspondence Address: TIMOTHY J. SLABOUZ, NEXSEN PRUET JACOBS & POLLARD LLC, PO DRWR 2426, COLUMBIA, SC, 29202-2426, US

(21) Appl. No.: 09/939,434

(22) Filed: Aug. 24, 2001

(51) Int. Cl. B42D 15/00

(52) U.S. Cl. 283/117

(57) ABSTRACT

A greeting card has separate healthcare or home healthcare-related information for the card recipient and the card giver. Preferably, the card recipient is a person recovering from a serious illness or is someone that is chronically ill while the card giver is the card recipient's home healthcare provider or caregiver. Preferably, the information provided is relevant to a specific medical illness or condition, or relevant to the home healthcare of the elderly. Furthermore, the card giver's information may be provided to the card giver/caregiver in a more straightforward manner since the caregiver has a need to know the seriousness of the medical condition/illness while the card recipient may not have the mental or emotional fortitude to accept the serious nature or outcome of the card recipient's medical illness/condition at that stage of the medical illness'/condition's progression. Other embodiments of this information delivery system are also described.

### 1. FIELD OF THE INVENTION

The present invention relates to greeting cards and to healthcare. In particular, the present invention relates to greeting cards that provide healthcare information to both the recipient and the giver of the card.

### 2. BACKGROUND OF THE INVENTION

Greeting cards are articles of manufacture that are generally made of card stock or other paper products having weights and thicknesses greater than ordinary stationery, and they are usually imprinted with writings and/or graphics suitable to the purpose or occasion for which they are being given. Greeting cards are given for many different reasons, and usually in connection with various significant occasions in people's lives including birthdays, graduations, weddings, the birth of a child, or promotions. Greeting cards are also given for more somber reasons, for example, “get well” cards are given to people that have suffered a serious illness, and “sympathy” cards are given to people that have experienced a loss of a family member. Overall, greeting cards provide a convenient means for a person to convey a wide variety of messages to the recipient of the card-ranging from the humorous to the most serious.

It is known in the prior art that greeting cards are made in many different styles including postcard type cards to multiple page cards. It is also known in the prior art that greeting cards can have detachable sheets, for example, the patent issued to Sinnott et al. U.S. Pat. No. 4,826,211, teaches a multiple sheet greeting card that has a detachably attached sheet, and the patent issued to Gaines U.S. Pat. No. 5,437,478, teaches a greeting card with a detachable receipt. Furthermore, it is also known in the prior art that greeting cards can contain health-related information. For example, see the patent to Harris U.S. Pat. No. 5,923,556, for a greeting card and method for imprinting a portion of a card giver's electrocardiogram wave on a greeting card, and, also see, the patent to Seabrook U.S. Pat. No. 5,954,369, which teaches a greeting card that contains a pocket for holding a medical “test kit,” and which may contain information regarding medical checkups that maybe appropriate for the card recipient based on the card recipient's age. It is also well known that health-related information is available from a variety of sources and for a variety of reasons. For example, the United States Navy has its Virtual Navy Hospital website at http://www.vnh.org. This website provides health-related information covering a wide range of medical conditions through the use of separate healthcare provider and patient specific web-links.

Because of the dramatic progress that has been achieved throughout the field of medicine, including in the areas of medical technology, treatment, and healthcare, more and more people are surviving health conditions that were previously life ending. This, among other causes, has contributed to the increase in the life expectancy and the average age of our population. To pay for this progress and technology, healthcare costs have risen to ever higher levels, which is precluding many Americans from being able to afford personal medical insurance, and which is increasingly forcing more and more employers away from providing medical coverage to their employees. Currently, over 40 million Americans have no medical insurance, and for those that do, many have insufficient insurance coverage, (e.g., the insured's medical insurance does not provide coverage for the treatment or the level of care required by the insured or the insured's family, or the insured is forced to pay for other unaffordable out-of-pocket costs, including costs associated with third party provided assisted-living services, or with nursing home care).

Therefore, a growing number of people are becoming caregivers, and are providing home healthcare for their friends or relatives who are recovering from illnesses, who are chronically ill, or who are elderly and not completely able to care for themselves. Consequently, it would be particularly useful to be able to convey health-related information in a format that focuses on the information needs of the individuals receiving the information, such as a chronically ill family member and that family member's caregiver, and it would be even more useful if multiple needs could be met through a common information delivery system like a greeting card. However, even though greeting cards come in a wide variety of styles, greeting cards that contain separate giver and recipient health-related and/or healthcare-related information are not known in the prior art.

### SUMMARY OF THE INVENTION

According to its major aspects and briefly recited, the present invention is a greeting card that is designed to satisfy the aforementioned needs to deliver healthcare-related information, while allowing the information to be tailored to the information needs and sensitivities of the card giver and the card recipient. Preferably, the greeting cards of the present invention would contain health and healthcare-related information focused on a specific medical condition, health issue, illness, or disease. For example, in one preferred embodiment, the hepatitis C greeting cards would provide two information packets, one for the recipient and one for the card giver, and preferably, these information packets would be distinguishable by being appropriately labeled and/or possibly color-coded. In continuing this example, the recipient would be a person that has contracted hepatitis C, and the recipient's information packet would contain important information on the disease including, for example, foods and activities that should be avoided. The card giver, who, preferably, is also the card recipient's caregiver, (i.e, the person providing home healthcare to the card recipient), would be provided with an information packet that would not only contain information similar to that provided in the recipient's packet, but would also contain other content sensitive information—such as warning signs of depression, and what actions to take to prevent its occurrence or to care for it in the event that such depression develops. The caregiver's information packet may also contain information alerting the caregiver of warning signs associated with the progression of the illness or failure to follow dietary or other recommendations, and, based on these signs, what actions the caregiver may need to take.

The present invention is the combination of a greeting card and health-related information packets. The card recipient's information packet maybe permanently attached to the greeting card. Preferably, however, the greeting card has one or more pockets for holding the information packets, or either or both information packets may use perforated sheets for attachment to the greeting card and for easy removal of either or both information packets. Preferably, the caregiver's information packet is removed from the greeting card by the card giver before the greeting card is given to the greeting card recipient. Preferably, the text and/or graphics imprinted on the greeting card, and/or on the caregiver's information packet, refers to the health-related issue that the specific greeting card is associated with, which would also allow this reference to be used as a means to classify, display, and stock the cards.

A major feature of the present invention is a greeting card having a combination of useful components. One component is the card, with its associated text and graphics and the recipient-based health-related information, which may be permanently attached to the card or, in one of the preferred embodiments, is detachable from the main card body. Another component, which is removable from the main card body, is the health-related information for the caregiver. Still another feature is the step of vending the card from the same sources that other greeting cards are vended, including pharmacies. As an example, the greeting cards of the present invention can be displayed in the general location of the pharmacy, or drugstore, that medications for the person being cared for are being picked-up.

An advantage of the present invention is that it allows for the dissemination of important health and/or healthcare information to individuals that may be in the role of caregiver to their friends, relatives, or other loved ones. The information provided to the caregiver can range from general healthcare guidance for the medical condition, or health issue of concern, to more specific information, which may include information regarding the recipient's emotional health, and/or the mental and emotional health of the caregiver, which may be stressed due to the responsibility of caring for a friend, relative, or loved one that is no longer able to care for themselves.

Another advantage of the present invention is that it provides the recipient with the recipient's own health-condition related information, which may make it less difficult for the recipient to maintain a better state of health for an even longer period of time under the circumstances.

Still another advantage of the present invention is that the giver of the card might be better able to emotionally handle information about the card recipient's medical condition, while the recipient would still be able to receive pertinent health and/or healthcare-related information in the same greeting card. Another related advantage is that individuals, other than direct caregivers, may be motivated to be more informed about their relative's or friend's health-related issues. This knowledge would allow these individuals to be of more assistance, or more helpful, to their friends or relatives, or, perhaps more importantly, to be more aware of what is involved in the situation, and what everyone is coping with.

These and other features and their advantages will be apparent to those skilled in the art from a careful reading of the Detailed Description of a Preferred Embodiment presented below and accompanied by the Drawings.

### BRIEF DESCRIPTION OF THE DRAWINGS

In the figures,

FIG. 1 is a perspective, partially exploded, view of a greeting card, which shows the card giver's, e.g., caregiver's, information packet being removed from the main card body, and the card recipient's information packet still contained in a main card body pocket, according to a preferred embodiment of the present invention;

FIG. 2 is a perspective view of a greeting card, which shows the card giver's, e.g., caregiver's, information packet being attached to the main card body by perforations, according to another preferred embodiment of the present invention;

FIG. 3 is a perspective, partially exploded, view of a greeting card, which shows the card giver's, e.g., caregiver's, and the card recipient's information packets being removed from pockets on the main card body, according to another preferred embodiment of the present invention;

FIG. 4 is a perspective view of a greeting card, which shows the card giver's, e.g., caregiver's, information packet being attached to the main card body by a removable adhesive, according to another preferred embodiment of the present invention; and

FIG. 5 is a perspective view of a greeting card, which shows the card giver's, e.g., caregiver's, information packet being attached to the main card body by perforations, according to another preferred embodiment of the present invention

### DETAILED DESCRIPTION OF A PREFERRED EMBODIMENT

The term “caregiver” when used in the following paragraphs refers to the person that is providing home healthcare to a person that is recovering from a serious illness or other medical condition, or to a person that is chronically ill or is terminal; generally, the caregiver is also the giver of the present invention card, and hereinafter the terms “caregiver” and “card giver” should be considered as being interchangeable.

The term “card recipient” when used in the following paragraphs refers to the person being cared for by the caregiver and to the person who receives the present invention card.

The terms “health-related” and “healthcare-related” when used in the following paragraphs should be considered as being interchangeable.

The terms “greeting card” and “card” when used in the following paragraphs should be considered as being interchangeable.

The term “information packet” when used in the following paragraphs refers to any of the following, as determined by the present invention context in which it is used: the health-related information imprinted on, or attached to, the main body of a greeting card; the detachable or removable single-page or multi-page collection of health-related information carried by a greeting card; or the single detachable portion of a greeting card, which can be either folded over the main body of a closed greeting card or folded within the main body of a closed greeting card, and which contains the caregiver's health-related information.

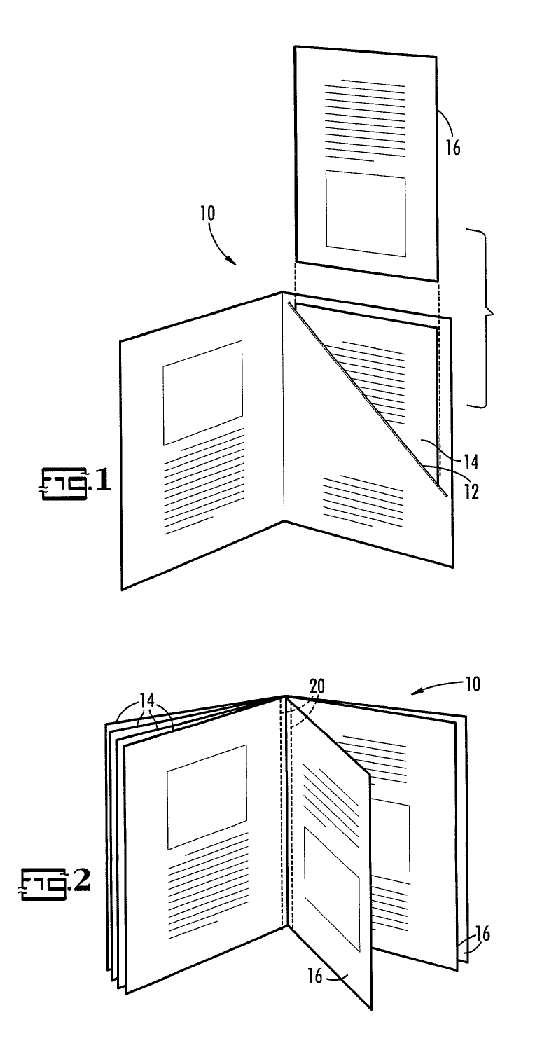

Referring now to FIGS. 1-4, there is illustrated healthcare-related greeting cards 10. The greeting cards 10, with the exception of one or more pockets 12 being formed and the provision of healthcare-related information packets 14 and 16, are similar to standard greeting cards. Cards 10 are imprinted with text, graphics, or text and graphics, that are related to the illness or medical condition that the specific card 10 is associated with.

Referring now to FIG. 1, there is illustrated a greeting card 10 with a pocket 12. The pocket 12 contains the recipient's healthcare-related information packet 14, which is removable from pocket 12. FIG. 1 also shows that the caregiver's information packet 16, which formerly was carried by pocket 12, has been removed from pocket 12. Preferably, the caregiver would remove the caregiver's information packet 16 from pocket 12 prior to giving the card 10 to the card recipient.

The recipient's healthcare-related information packet 14 contains content-specific information regarding the card recipient's illness or medical condition. For example, the information packet 14 may contain: (1) general background information on the illness or medical condition, e.g., the percentage of people in the United States that have the illness and condition, risk factors associated with the illness or medical condition, and the importance of obtaining regular medical practitioner provided check-ups; (2) specific healthcare-related information, e.g., for diabetes the information may cover the types of diabetes, learning how to control the type of diabetes that the card recipient may have, monitoring blood sugar levels and treating high blood sugar levels, preventing and diagnosing long-term diabetes related problems, and getting checked for long-term problems, and how to treat such problems if they should occur.

The caregiver's healthcare-related information packet 16 also contains content-specific information regarding the card recipient's illness or medical condition. For example, information packet 16 may contain the same general background and the same specific information, on the illness or medical condition, that is contained in information packet 14 and may additionally provide information regarding other sources of relevant information. Furthermore, caregiver's healthcare-related information packet 16 may provide information related to home healthcare and/or to the prevention and diagnoses of long-term and short-term problems associated with the illness or medical condition; for example, if dry skin, sensitivity to light, or digestion problems are symptomatic of the specific illness or medical condition of interest, or are side-effects associated with the medicines generally prescribed for the specific illness or condition, then information packet 16 may provide information concerning warning signs to watch for and the actions to take if these symptoms or conditions manifest themselves. However, in a preferred embodiment, all of the information provided to the caregiver in information packet 16 will be matter-of-fact and straightforward. In this regard, the caregiver's information packet 16 may also provide information on the subjects of loss, grief and bereavement along with information which may be useful in organizing the card recipient's financial affairs. Furthermore, information packet 16, if appropriate, will also provide the caregiver with warning signs regarding the emotional health and well-being of the card recipient, as well as that of the caregiver, and what actions to take based on these conditions or warning signs. By providing this information to the caregiver, the caregiver could possibly be in a better position to make healthcare and non-healthcare related decisions, up to and including those related to the card recipient's death.

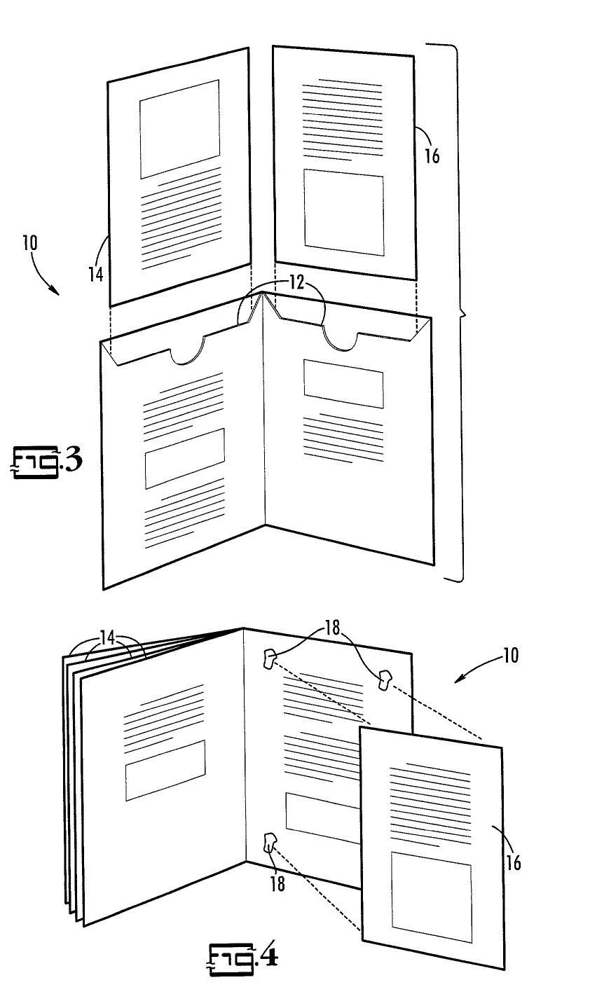

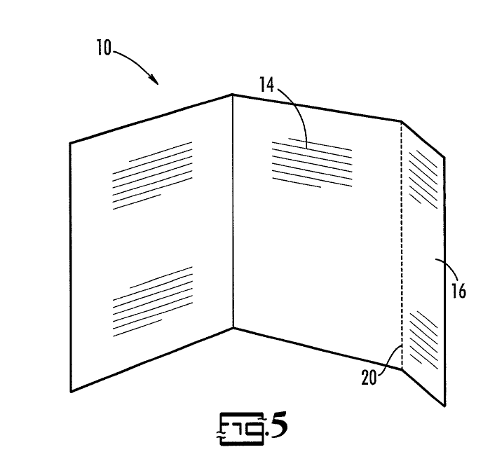

Referring now to FIGS. 2-4, these are other preferred embodiments of the card 10. FIG. 2 shows the recipient's information packet 14, and the caregiver's information packet 16, being perforated 20 so that they can be removed from card 10. FIG. 3 shows card 10 having two pockets 12 for separately carrying the information packets 14 and 16. FIG. 4 shows the recipient's information packet 14 being bound to card 10, and the caregiver's information packet 16 being removably attached to one of the pages of the card 10 by a removable adhesive 18, which can be removed from the card, if desired.

Referring now to FIG. 5, this is another preferred embodiment of the card 10. FIG. 5 shows the recipient's information packet 14 being imprinted onto the main body of the card 10, and the caregiver's information packet 16 being perforated 20 so that it is removable from the main body of the card 10. The caregiver's information packet 16 is a single page, or bookmark sized, portion of the card 10. Preferably, the caregiver's information packet 16 is dimensioned in a range from about one inch in width to about the width of a closed card 10. This will allow the caregiver's information packet 16 to be either folded over the main body of a closed card 10 or folded within the main body of a closed card 10. Preferably, the caregiver's healthcare-related information is imprinted on both sides of the caregiver's information packet 16, but it may be imprinted on only one side, if desired. The information associated with this card, for example, may be in the following format: Imprinted on the main card body may be a health condition related greeting accompanied by a message from the cardgiver's perspective concerning an offer of “care giving”; Imprinted on the detachable cardgiver's portion of the card may be general and, possibly, specific health condition related information along with wording along the lines of “Cardgiver-Please Detach This Portion For Your Future Use.”

The preferred embodiment and the best mode of the healthcare-related greeting cards 10 of the present invention are described herein. However, it should be understood that the best mode for carrying out the invention heretofore described is by way of illustration and not by way of limitation. It is intended that the scope of the present invention includes all modifications that do not depart from the spirit and scope of the present invention, and that the scope and limitations of the present invention are to be determined by the scope of the appended claims and their equivalents.

What is claimed is:

1. An article of manufacture, comprising:
a greeting card, said greeting card containing text and graphics;
a card recipient's information packet carried by said greeting card; and
a card giver's information packet carried by said greeting card.

2. The article as recited in claim 1, wherein said card giver's information packet is detachable from said greeting card.

3. The article as recited in claim 1, further comprising means for removably carrying said card giver's information packet and said card recipient's information packet.

4. The article as recited in claim 3, wherein said carrying means is at least one pocket formed on said greeting card.

5. The article as recited in claim 1, wherein said card giver's information packet and said card recipient's information packet contain healthcare-related information.

6. The article as recited in claim 1, wherein said card giver's information packet and said card recipient's information packet contain home healthcare-related information.

7. The article as recited in claim 6, wherein said card giver's information packet and said card recipient's information packet contain both general and specific information, said general and specific information are both related to a specific medical illness.

8. The article as recited in claim 6, wherein said card giver's information packet and said card recipient's information packet contain both general and specific information, said general and specific information are both related to a specific medical condition.

9. The article as recited in claim 6, wherein said card giver's information packet and said card recipient's information packet contain both general and specific information, said general and specific information are both related to a class of medical illnesses.

10. The article as recited in claim 6, wherein said card giver's information packet and said card recipient's information packet contain both general and specific information, said general and specific information are both related to a class of medical conditions.

11. An article of manufacture comprising:
a greeting card, said greeting card containing text and graphics;
a card recipient's information packet carried by said greeting card, said information packet containing general and specific information on a subject from the group consisting of a specific medical illness, a specific medical condition, and elderly healthcare; and
a card giver's information packet removably carried by said greeting card, said information packet containing general and specific information on a subject from the group consisting of a specific medical illness, a specific medical condition, and elderly healthcare.

12. The article as recited in claim 11, wherein said text and graphics correspond to the subject of the greeting card.

13. The article as recited in claim 11, further comprising at least one pocket formed on said greeting card for carrying said card recipient's information packet and said card giver's information packet.

14. The article as recited in claim 11, wherein said card giver's information packet is detachable from said greeting card by use of perforations.

15. The article as recited in claim 11, wherein said card giver's information packet is detachably carried by said greeting card by use of an adhesive.

16. The method of delivering dual user, user-specific and medical-subject-specific healthcare information packets comprising the steps of:
acquiring card stock;
imprinting said card stock with text and graphics corresponding to said medical-subject;
imprinting said card stock with each of said dual user's said user-specific medical-subject-specific healthcare-related information;
separating said imprinted information into separate user-specific information packets;
gathering all said user-specific information packets;
forming said user-specific information packets into a healthcare greeting card;
removably attaching one of said dual user's said information packets from said formed healthcare greeting card;
displaying said healthcare greeting card in a retail outlet where greeting cards are normally sold, said displaying of said healthcare greeting card arranged in such a way that the location of said healthcare greeting card, in relation to all other healthcare greeting cards, generally corresponds to the part of the human body said information packets contained in said healthcare greeting card corresponds to; and
displaying said healthcare greeting card in a retail outlet where prescription medicines and non-prescription medicines are normally sold, said displaying of said healthcare greeting card arranged in such a way that the location of said healthcare greeting card, in relation to all other healthcare greeting cards, generally corresponds to the part of the human body said information packets contained in said healthcare greeting card corresponds to.
